(19) United States
(12) Patent Application Publication
(10) Pub. No.: US 2019/0108301 A1
(43) Pub. Date: Apr. 11, 2019

(54) CHIP POWER MODEL GENERATION USING POST SILICON MEASUREMENTS

(71) Applicant: Seagate Technology LLC, Cupertino, CA (US)

(72) Inventors: Nitin Kumar Chhabra, Maharashtra (IN); Pritesh Mahadev Pawaskar, Maharashtra (IN); William Harrison Hempy, II, Rochester, MN (US); Gaurav Mathur, Maharashtra (IN)

(21) Appl. No.: 15/725,961

(22) Filed: Oct. 5, 2017

(51) Int. Cl. G06F 17/50

(52) U.S. Cl. CPC G06F 17/5036; G06F 2217/78

(57) ABSTRACT

A method of generating a chip power model (CPM) for a chip by determining a current profile measurement on a validation board for the chip, and stressing the chip using a plurality of stress factors. A stressed measured waveform is captured and stored. A CPM is generated with the measured waveform captured using the plurality of stress factors. A simulation waveform is captured and stored from the CPM. The measured and simulation waveforms are compared, and when the measured and simulation waveforms do not match, at least one parameter of the CPM is modified iteratively until the measured and simulation waveforms match.

### SUMMARY

In one embodiment, a method of generating a chip power model (CPM) for a chip includes determining a current profile measurement on a validation board for the chip, and stressing the chip using a plurality of stress factors. A measured waveform of the stressed chip is captured and stored. A CPM is generated with the measured waveform. From the generated CPM, a simulation waveform is captured and stored. The measured and simulation waveforms are compared, and when the measured waveform and the simulation waveform do not substantially match, at least one parameter of the CPM is modified iteratively until the measured and simulation waveforms substantially match.

In another embodiment, a method of generating a power model for a chip includes stressing the chip with a plurality of parameters simulating real-world operation, measuring deviation of current waveforms of the stressed chip from known current waveforms, and generating a power profile for the chip. A preliminary CPM is generated including a timing model using the generated power profile, the plurality of parameters, and input current and voltage. Current waveforms of the chip power model are compared with the known current waveforms, and at least one parameter of the chip power model is modified when the waveforms of the CPM and the known current waveforms differ by more than a predetermined amount. Comparing and modifying are repeated until the waveforms of the CPM and the known current waveforms do not differ by more than the predetermined amount.

In another embodiment, an apparatus includes a processor and a measurement device coupleable to a chip to stress and to measure parameters of the chip. The processor is configured to determine a current profile measurement on a validation board for the chip, stress the chip using a plurality of stress factors, and capture and store a stressed laboratory waveform. The processor is further configured to generate a CPM with the waveform captured using the plurality of stress factors, capture and store from the CPM a simulation waveform, and compare the laboratory and simulation waveforms. When the laboratory and simulation waveforms do not substantially match, at least one parameter of the CPM is iteratively modified until the laboratory and simulation waveforms substantially match.

This summary is not intended to describe each disclosed embodiment or every implementation of the CPM generation described herein. Many other novel advantages, features, and relationships will become apparent as this description proceeds. The figures and the description that follow more particularly exemplify illustrative embodiments.

### BRIEF DESCRIPTION OF THE DRAWINGS

FIG. 1 is a block diagram of a system on which embodiments of the present disclosure may be practiced;

FIG. 2 is a diagram of a power delivery network process flow according to an embodiment of the present disclosure;

FIG. 3 is a block diagram of a chip power model generation module according to another embodiment of the present disclosure;

FIG. 4 is a flow chart diagram of a method according to an embodiment of the present disclosure;

FIG. 5 is a block diagram of operation of a method of testing a CPM according to an embodiment of the present disclosure;

FIG. 6 is a flow chart diagram of a detailed decision module of the method of FIG. 5 according to another embodiment of the present disclosure;

FIG. 7 is a block diagram of a data storage device on which embodiments of the present disclosure may be used; and

FIG. 8 is an oblique view of a solid state drive (SSD) on which embodiments of the present disclosure may be used.

### DETAILED DESCRIPTION OF ILLUSTRATIVE EMBODIMENTS

This disclosure generally describes a method for generating a chip power model (CPM) that takes into account actual stress conditions in post-silicon stress testing. This method combines CPM generation and post-silicon validation to provide a power and timing profile more closely aligned with real-world conditions, including for an input/output (I/O) power domain.

Embodiments of the disclosure describe a method of generating a CPM by stressing a chip with a number of stressors, comparing waveforms with desired waveforms to create a power profile, and then generating the CPM using the parameters. Following this, the CPM waveforms are compared with the desired waveforms, and a timing model may be adjusted iteratively to match the desired waveforms. This allows generation of the CPM taking into account stress profiles instead of only a theoretical design.

It should be noted that the same reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Generally, generation of a CPM and post-silicon validation of integrated circuits are separate and distinct processes. A CPM is a model of a full-chip power delivery network. CPMs are generally used only in the design phase of an integrated circuit, and are therefore only generated based on library models. Validation of CPM is a cumbersome process. Post-silicon validation is used to test a chip design in a real-world environment (e.g., an environment in the field or away from the laboratory), and is typically performed on actual devices running in real-world systems, often using logic analysis and assertion-based tools.

CPMs are not traditionally generated for an I/O power domain. Standard delivery of I/O power does not typically contain a power model. Also, timing information for an I/O model is not usually accurate in an initial timing file. Accordingly, a CPM, being based only on a design, does not take into account real-world measurements and conditions. CPMs therefore do not typically replicate real silicon behavior closely, and post-silicon validation results in changes to designs that may be costly, time consuming, and delay actual production.

Embodiments of the present disclosure are directed toward generation of a CPM that mitigates differences between simulation results and actual real-world silicon performance. A CPM generated using the embodiments of the present disclosure accounts for power domains such as the I/O power domain, as well as the stress and variability of real-world operation, by adjusting an initial CPM based on post-silicon measurement of current profiles. Accordingly, a CPM is provided that takes into account real-world operation and power domains of an entire chip, including its I/O power domain.

Embodiments of the present disclosure further provide methods for adjusting a CPM to account for real-world operation. Embodiments of the disclosure may be used, for example, by system on chip (SoC) vendors, which validate the SoC only and provide the inputs to various different system teams. Method embodiments of the present disclosure provide a CPM of various power domains of an entire chip including the I/O power domain.

In general, embodiments of the present disclosure capture current waveforms from a validation board. A chip or chips of the board are then stressed to an expected worst case scenario for operating conditions in the real world. Deviation in current profiles are determined. Stress factors include for example simultaneous switching output (SSO) patterns, activity factors of individual blocks, and process/voltage/temperature (PVT) conditions. Once the desired stress is achieved, these parameters along with input DC voltage and DC current are used for CPM generation. An iterative process to adjust the model is used to generate a final CPM.

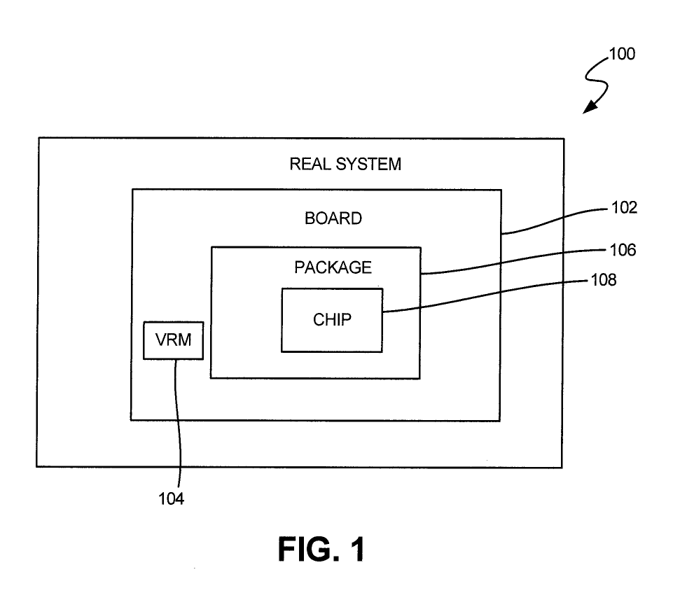

FIG. 1 is a block diagram of a system 100 on which embodiments of the present disclosure may be practiced. System 100 comprises a validation board 102, which is a printed circuit board. Validation board 102 includes a voltage regulator module (VRM) 104, which functions in one embodiment to supply voltage and current to various chips 108 through packages 106 which are molded on the board 102. While system 100 is shown with one package area 106 on the board 102, it should be understood that the system 100 in the field may have several packages which are molded on the board 102.

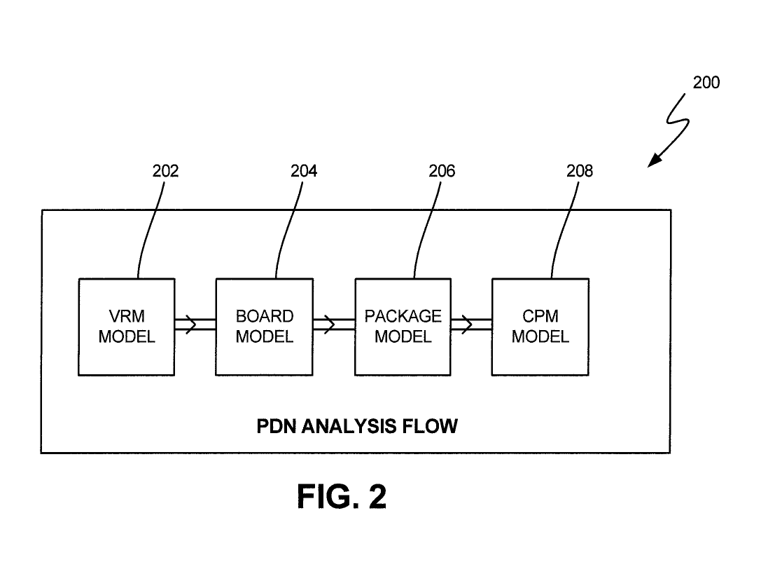

In one embodiment, a power delivery network (PDN) analysis is a part of the function of the process (see FIG. 2). Modeling a chip from a power perspective using PDN analysis is used in one embodiment to determine whether power delivery is sufficient to all chips on a board. That is, all chips on a board have sufficient power for operation under real-world operating conditions.

FIG. 2 shows a flow chart of PDN analysis flow 200 according to one embodiment. PDN analysis uses a VRM model 202, a board model 204, a package model 206, and a CPM model 208. VRM model 202 is generally provided by a vendor. For the board model 204, a 3D extractor is used to extract a board model 204 including parameters for all boards. For the package model, a similar extract is made to obtain the package model 206. CPM model 208 is generated from a CPM generation module. VRM 202 acts as a source while CPM is the sink, with the board and package being the channel elements. Current flows from VRM to CPM via the board and package. A complete system is simulated to determine what a power delivery profile for the system looks like across each interface (VRM/Board/Package/CPM).

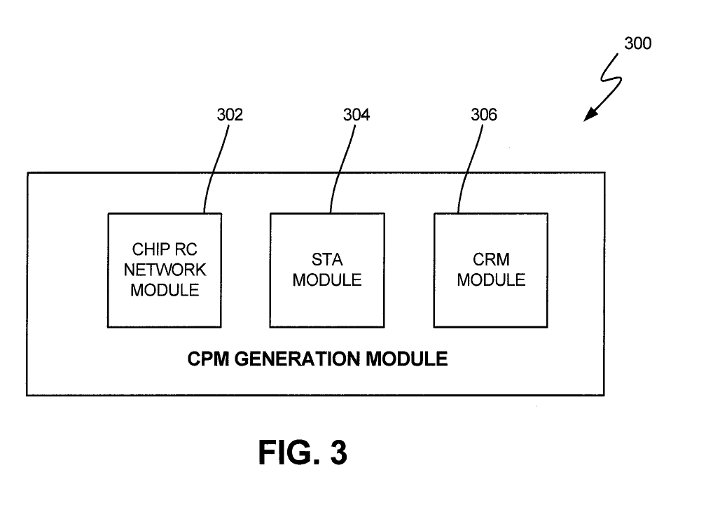

FIG. 3 is a block diagram of a CPM generation module 300 according to one embodiment. CPM generation module 300 comprises in one embodiment a chip/die resistor-capacitor (RC) network module 302, a static timing analysis (STA) module 304, and a current regulator model (CRM) module 306, each of which provides an input for generation of the CPM. RC network module 302 contains design specifications for the RC network of the die. STA module 304 contains timing information, in one embodiment stored in an American Standard Code for Information Interchange (ASCII) file. CRM module 306 contains a power model for the die. These three modules 302, 304, and 306 provide inputs for the CPM generation module 300 for its generation of a CPM for the PDN analysis flow 200.

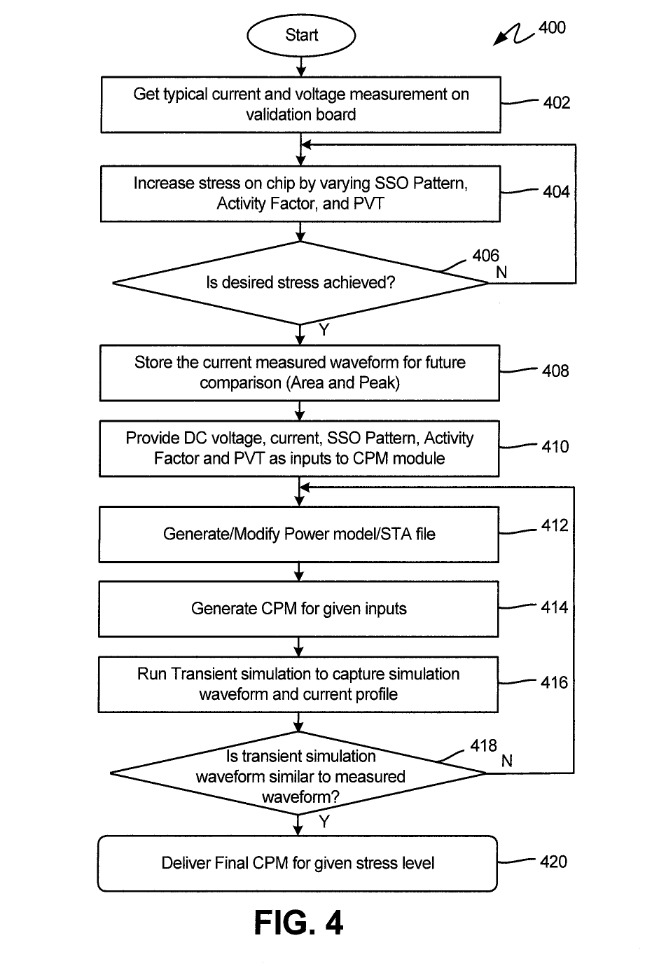

FIG. 4 is a flowchart of a method 400 for generation of a CPM, according to one embodiment. Method 400 comprises determining a current profile measurement on the validation board in block 402. Once the system is operational and functional, the chip is stressed in block 404. Stressing of the chip in one embodiment comprises stressing based on various factors and parameters of the chip and system, including by way of example and not by way of limitation, simultaneous switching output (SSO) pattern, activity factor, process/voltage/temperature (PVT) variations, and the like.

As the ultimate use of each chip/system is known before testing, the testing parameters that are stressed are in one embodiment tailored to an expected worst case scenario for conditions and operation of the chip. For example, if a chip is to be used in a particular product, that product will have specifications of how it will be used, and the expected worst case operational parameters will be known. The chip in the process of FIG. 4 is stressed based on how it will be used, and the expected worst case scenario of real-world operation. This stress is induced in a laboratory setting in block 404.

A determination is made as to whether the desired stress has been achieved in decision block 406. If not, the process returns to block 404 to increase stress on the chip. Once the desired stress level is induced, the current waveform is captured and stored in block 408. In one embodiment, the measured waveform area (A_{Meas}) and measured peak amplitude (P_{Meas}) are stored. Once the measured waveform is stored in block 408, the parameters of the stress and waveform are provided as inputs to the CPM module in block 410. In one embodiment, the parameters include, for example, all of the stress factors and all operating conditions of the chip. Such parameters include DC voltage, current, SSO, activity factors of individual blocks, PVT information, and the like as inputs to the CPM module. Using those inputs, a power model and timing file (STA) are generated or modified at block 412. For the given inputs, a CPM is generated at block 414. Once the CPM is generated, a transient simulation is run in block 416, to capture the current waveform. In one embodiment, the current waveform area (A_{CPM}) and current peak amplitude (P_{CPM}) are stored.

This captured current waveform from block 416 is a simulation waveform. In decision block 418, the captured current CPM waveform (416) is compared to the measured waveform (laboratory measured waveform from block 408). If the measured and captured CPM waveforms match or substantially match, process flow continues at block 420 where the current CPM is delivered as the final CPM. If the measured and captured waveforms do not match, process flow continues at block 412, where modification of parameters is performed to modify change one or more of the power model and STA file. With new parameters, process blocks 414 and 416 are executed again. The process continues iteratively until the current CPM waveform and the measured waveform are similar, in one embodiment to within a predetermined tolerance.

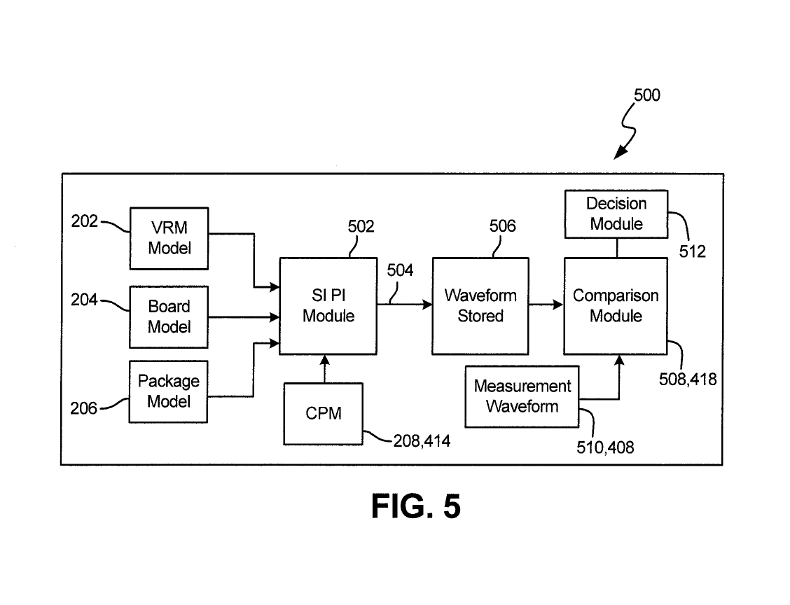

FIG. 5 is a block diagram of operation of a method of testing the CPM from block 414 in more detail. It details the functions of block 414, 416, and 418 in further depth. In FIG. 5, the various generated models, VRM model 202, board model 204, package model 206, and intermediate CPM 208 (from block 414) are used as inputs to signal integrity/power integrity (SI/PI) module 502 to carry out the transient analysis. SI/PI module 502 performs signal integrity (SI) and power integrity (PI) testing on the system using the VRM model 202, board model 204, package model 206, and generated CPM (from 414). The resultant SI/PI simulation waveform output 504 is stored at block 506. This waveform 504 is compared at comparison module (block 508) with the measured laboratory waveform (provided at 408). Based on that comparison, a decision model is generated at decision module 512 to determine whether the intermediate CPM (from block 414) is acceptable for implementation, or whether further adjustments are to be made to the CPM.

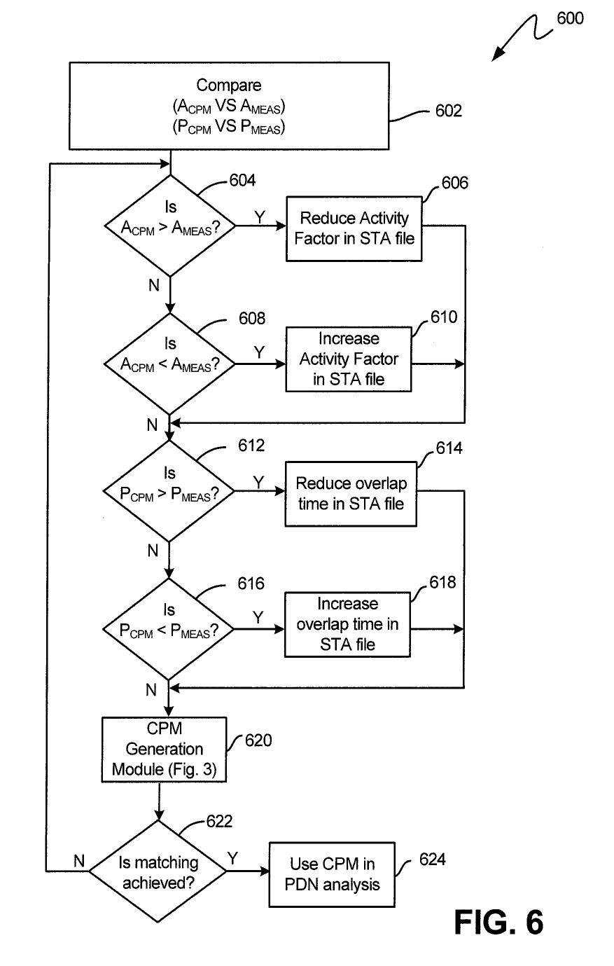

A flow chart of a method 600 for adjusting the intermediate CPM (from block 414) based on decision block 512 is shown in FIG. 6. Method 600 performs comparison of two parameters from the intermediate CPM (414) to the measured waveform parameters (408). In one embodiment, the parameters compared for the waveforms are (1) the areas (A) under the curve of the waveform for the CPM A_{CPM} and the measured waveform (408) A_{MEAS}, and (2) the peak amplitudes (P) for the waveform of the CPM P_{CPM} and the measured waveform (408) P_{MEAS}. The shape (e.g., area under the curve) and the peak amplitude for the two waveforms are compared.

Method 600 comprises in one embodiment beginning a comparison of the areas and peak amplitudes in block 602. The remaining decision blocks 604, 608, 612, 616, sequentially perform the comparisons of various areas and amplitudes. In decision block 604, if A_{CPM} (of the intermediate CPM) is greater than A_{Meas} (measurement), the activity factor is reduced in the STA file in block 606. The amount of reduction of the activity factor depends in one embodiment on the amount of variation between A_{CPM} and A_{Meas}. If the variation is small (<5%), the activity factor is reduced by 2%. If the variation is large (>5%), the activity factor is reduced by 5%. A decrease in the activity factor decreases the area under the curve of the A_{CPM}. In one embodiment, 5% is a cut off for determining whether the variation is small or large. For a % calculation, A_{Meas} is taken as a reference and variation is determined according to the calculation Variation %=100*(A_{CPM}−A_{Meas})/A_{Meas}.

If A_{CPM} is less than A_{Meas}, as determined by decision block 608, then the activity factor in the STA file is increased in block 610. The amount of increase of the activity factor depends in one embodiment on the amount of variation between A_{CPM} and A_{Meas}. If the variation is small (<5%), the activity factor is increased by 2%. If the variation is large (>5%), the activity factor is increased by 5%. An increase in the activity factor increases the area under the curve of the A_{CPM}. In one embodiment, 5% is a cut off for determining whether the variation is small or large. For a % calculation, A_{Meas} is taken as a reference and variation is determined according to the calculation Variation %=100*(A_{Meas}−A_{CPM})/A_{Meas}.

Following an increase or decrease in the activity factor in the STA file, from blocks 606 or 610, or if the A_{CPM} is equal to A_{Meas}, the method proceeds to decision block 612, in which the P_{CPM} and P_{Meas} are compared. In decision block 612, if P_{CPM} (intermediate CPM) is greater than P_{Meas} (measured), an overlap time (between I/Os) is reduced in the STA file in block 614. Overlap time is in one embodiment a common time period between the switching currents of various I/Os. The amount of reduction of the overlap time also depends in one embodiment on the amount of variation between P_{CPM} and P_{Meas}. If the variation is small (<5%), the overlap time is reduced by 2%. If the variation is large (>5%), the overlap time is reduced by 5%. A decrease in the overlap time decreases the peak amplitude of the P_{CPM}. In one embodiment, 5% is a cut off for determining whether the variation is small or large. For a % calculation P_{Meas} is taken as reference and variation is determined according to the calculation Variation %=100*(P_{CPM}−P_{Meas})/P_{Meas}.

If P_{CPM} is less than P_{Meas}, as determined by decision block 616, then the overlap time in the STA file is increased in block 618. The amount of increase of the overlap time depends in one embodiment on the amount of variation between P_{CPM} and P_{Meas}. If the variation is small (<5%), the overlap time is increased by 2%. If the variation is large (>5%), the overlap time is increased by 5%. An increase in the overlap time increases the peak amplitude of the P_{CPM}. In one embodiment, 5% is a cut off for determining whether the variation is small or large. For a % calculation P_{Meas} is taken as a reference and variation is determined according to the calculation Variation %=100*(P_{Meas}−P_{CPM})/P_{Meas}.

Once the decision blocks (604, 608, 612 and 616) and action blocks (606, 610, 614 and 618) are complete, the process continues to block 620, in which a new CPM is generated by the CPM generation module 300 using the modified STA file. Details of the generation of the new CPM are similar to those described above. The new CPM is used in the method 500 to generate a new SI/PI output 504, and this new waveform is compared in comparison module 508 with the measured waveform. If the waveforms match as determined in decision block 622, the new CPM is used in PDN analysis in block 624. If the waveforms do not match, process flow continues at decision block 604, and an iterative process to adjust activity factor and/or overlap time is performed until the waveform for the current CPM matches the lab measured waveform. The embodiments of the present disclosure generate a CPM based on real-world validation parameters. Accordingly, the CPM represents real-world operation of the design as opposed to theoretical operation.

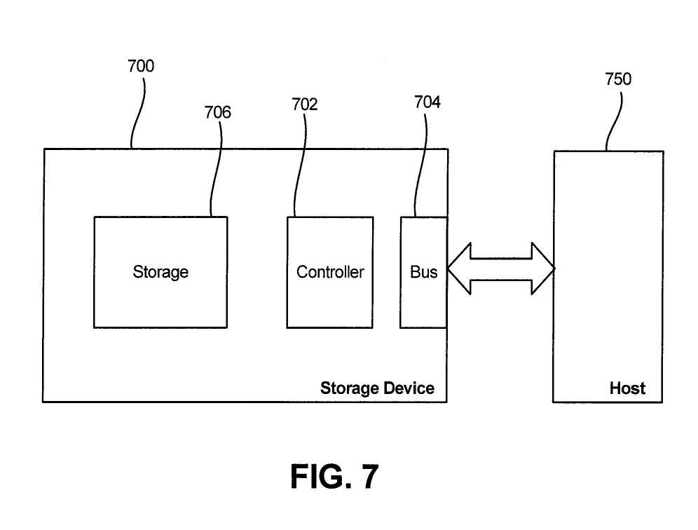

Referring now to FIG. 7, a simplified block diagram of a storage system 700 on which chips or systems in accordance methods of the present disclosure may be used is shown. Storage system 700 may be any storage system, such as is in one embodiment a hard disc drive (HDD) including by way of example rotatable discs; write heads; and associated controllers such as are known in the art; or in another embodiment a solid state drive including non-volatile memory and associated controllers such as are known in the art; or any other storage system for persistent storage of information. System 700 may include, by way of example, a controller 702 coupleable via a bus 704 or the like to a host system 750, where the host system 750 may provide power over the bus 704 or through a separate power bus (not shown), and a storage component 706 (such as rotatable platters or nonvolatile memory). CPM validation for chips in the system 700 may be performed and CPMs provided according to the methods described herein.

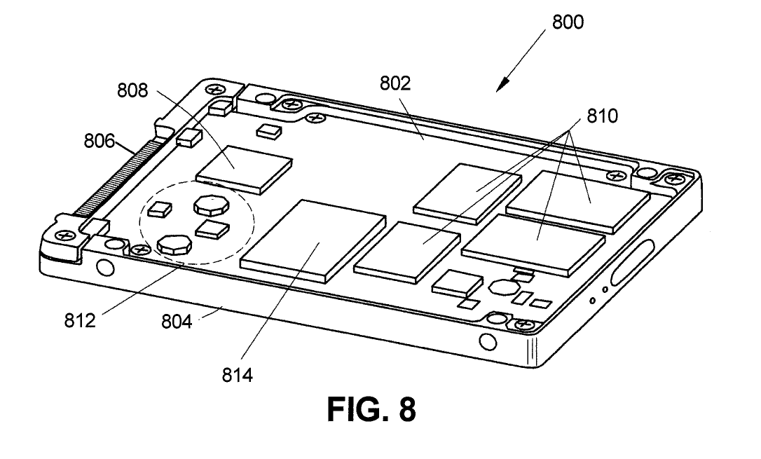

FIG. 8 illustrates an oblique view of a solid state drive (SSD) 800 in accordance with another embodiment on which chips or systems embodying the methods described herein may be used. SSD 800 includes one or more printed circuit boards (PCBs) or circuit card assemblies 802 and typically includes a protective, supportive housing 804, and one or more interface connectors 806. SSD 800 further includes a controller application specific integrated circuit (ASIC) 808, one or more non-volatile memory devices 810, and power regulation circuitry 812. The memory devices 810 are essentially the SSD's data storage media. SSD 800 may include erasure blocks as the physical storage locations within memory device 810, which may include Flash memory devices, for example. In some applications, SSD 800 further includes a power-backup energy storage device, such as a super-capacitor 814.

In accordance with certain aspects, the SSD 800 includes the circuit card assembly 802 that includes a connector 806 for connection to a host computer (not shown). In accordance with certain aspects, the connector 806 includes a NVMe (non-volatile memory express), SCSI (small computer system interface), SAS (serial attached SCSI), FC-AL (fiber channel arbitrated loop), PCI-E (peripheral component interconnect express), IDE (integrated drive electronics), AT (advanced technology), ATA (advanced technology attachment), SATA (serial advanced technology attachment), IEEE (institute of electrical and electronics engineers)-1394, USB (universal serial bus) or other interface connector adapted for connection to a host computer. CPM validation for chips in the system 800 may be performed and CPMs provided according to the methods described herein.

An apparatus according to an embodiment of the present disclosure includes a processor or other computer that includes a measurement device coupleable to a chip to stress the chip and to measure parameters of the chip. Stress factors configurable by the apparatus include those discussed elsewhere herein. The processor is configured in one embodiment to generate a CPM module for the chip using a method such as those described herein with respect to FIGS. 2 and 4-6.

Embodiments of the present disclosure generate a CPM based on real-world conditions. This CPM may be provided to and used by SOC vendors for further product development. Validation of designs using embodiments of the present disclosure embed validation into process flow in the lab before the CPM is provided to vendors. This allows for a low turn-around time for complete analysis, since validation is embedded in the process flow.

Further, with the same SOC system, variations may be made to do analysis for different conditions, allowing for testing of further or other conditions to modify the CPM. Embodiments of the present disclosure allow for system level SSO testing, including power analysis in the I/O domain.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and therefore are not drawn to scale. Certain proportions within the illustrations may be exaggerated, while other proportions may be reduced. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of generating a chip power model (CPM) for a chip, comprising:
determining a current profile measurement on a validation board for the chip;
stressing the chip using a plurality of stress factors;
capturing and storing a measured waveform of the stressed chip;
generating the CPM with the measured waveform of the stressed chip;
capturing and storing a simulation waveform from the CPM;
comparing the measured waveform and the simulation waveform; and
when the measured waveform and the simulation waveform do not substantially match, iteratively modifying at least one parameter of the CPM until the measured waveform and the simulation waveform substantially match.

2. The method of claim 1, wherein stressing the chip comprises:
adjusting at least one of the stress factors;
determining whether a desired stress level has been achieved; and
iteratively adjusting at least one of the stress factors when the desired stress level has not been achieved.

3. The method of claim 2, wherein adjusting at least one of the stress factors comprises adjusting at least one of an activity factor of an individual block of the chip, a simultaneous switching output pattern of the chip, an ambient pressure, an ambient volume, or an ambient temperature.

4. The method of claim 1, wherein iteratively modifying at least one parameter of the CPM comprises at least one of:
adjusting an area under a curve of the simulation waveform when the area under the curve of the simulation waveform differs from an area under a curve of the measured waveform; or
adjusting a peak amplitude of the measured waveform when the peak amplitude of the measured waveform differs from a peak amplitude of the simulation waveform.

5. The method of claim 4, wherein adjusting an area under the curve of the simulation waveform comprises:
decreasing the area under the curve of the simulation waveform when the area under the curve of the simulation waveform is greater than the area under the curve of the measured waveform.

6. The method of claim 5, wherein decreasing the area under the curve of the simulation waveform comprises reducing an activity factor in a static timing analysis file for the CPM.

7. The method of claim 6, wherein reducing an activity factor comprises reducing by a first percentage when the area under the curve of the simulation waveform is more than 5% greater than the area under the curve of the measured waveform, and reducing by a second percentage, less than the first percentage, when the area under the curve of the simulation waveform is more than 2% greater than the area under the curve of the measured waveform.

8. The method of claim 4, wherein adjusting an area under the curve of the simulation waveform comprises:
increasing the area under the curve of the simulation waveform when the area under the curve of the simulation waveform is less than the area under the curve of the measured waveform.

9. The method of claim 8, wherein increasing the area under the curve of the simulation waveform comprises increasing an activity factor in a static timing analysis file for the CPM.

10. The method of claim 9, wherein increasing an activity factor comprises increasing by a first percentage when the area under the curve of the simulation waveform is more than 5% less than the area under the curve of the measured waveform, and increasing by a second percentage, less than the first percentage, when the area under the curve of the simulation waveform is less than 2% greater than the area under the curve of the measured waveform.

11. The method of claim 4, wherein adjusting a peak amplitude of the simulation waveform comprises:
decreasing the peak amplitude of the simulation waveform when the peak amplitude of the simulation waveform is greater than the peak amplitude of the measured waveform.

12. The method of claim 11, wherein decreasing the area under the curve of the simulation waveform comprises reducing an overlap time in a static timing analysis file for the CPM.

13. The method of claim 12, wherein reducing an overlap time comprises reducing by a first percentage when the peak amplitude of the simulation waveform is more than 5% greater than the peak amplitude of the measured waveform, and reducing by a second percentage, less than the first percentage, when the peak amplitude of the simulation waveform is more than 2% greater than the peak amplitude of the measured waveform.

14. The method of claim 4, wherein adjusting a peak amplitude of the simulation waveform comprises:
increasing the peak amplitude of the simulation waveform when the peak amplitude of the simulation waveform is less than the peak amplitude of the measured waveform.

15. The method of claim 14, wherein increasing the peak amplitude of the simulation waveform comprises increasing an overlap time in a static timing analysis file for the CPM.

16. The method of claim 15, wherein increasing an overlap comprises increasing by a first percentage when the peak amplitude of the simulation waveform is more than 5% less than the peak amplitude of the measured waveform, and increasing by a second percentage, less than the first percentage, when the peak amplitude of the simulation waveform is less than 2% greater than the peak amplitude of the measured waveform.

17. A method of generating a power model for a chip, comprising:
stressing the chip with a plurality of parameters simulating real world operation;
measuring deviation of current waveforms of the stressed chip from known current waveforms;
generating a power profile for the chip;
generating a preliminary chip power model including a timing model using the generated power profile, the plurality of parameters, and input current and voltage;
comparing current waveforms of the chip power model with the known current waveforms;
modifying the timing model when the waveforms of the chip power model and the known current waveforms differ by more than a predetermined amount; and
repeating comparing and modifying until the waveforms of the chip power model and the known current waveforms do not differ by more than the predetermined amount.

18. The method of claim 17, wherein comparing the current and known waveforms comprises comparing area and peak amplitude of the current and known waveforms.

19. The method of claim 17, wherein generating the chip power model comprises:
generating a power library file using the plurality of stress factors and the determined current and voltage;
generating a static timing analysis (STA) file using the plurality of stress factors and the determined current and voltage; and
generating a switching pattern using the plurality of stress factors and the determined current and voltage.

20. An apparatus, comprising:
a processor; and
a measurement device coupleable to a chip to stress and to measure parameters of the chip;
wherein the processor is configured to:
determine a current measurement on a validation board for the chip;
stress the chip using a plurality of stress factors;
capture and store a stressed laboratory waveform;
generate the CPM with the waveform captured using the plurality of stress factors;
capture and store from the CPM a simulation waveform;
compare the laboratory and simulation waveforms; and
when the laboratory and simulation waveforms do not substantially match, iteratively modify at least one parameter of the CPM until the laboratory and simulation waveforms substantially match.
